(19) United States
(12) Patent Application Publication
(10) Pub. No.: US 2005/0131743 A1
(43) Pub. Date: Jun. 16, 2005

(54) Fare searching program and method

(76) Inventors: Suzie Callaway, Atlanta, GA (US); John Orsolits, Atlanta, GA (US); Eileen Lodisio, Atlanta, GA (US)

Correspondence Address: Hovey Williams LLP, Suite 400, 2405 Grand Blvd., Kansas City, MO, 64108, US

(21) Appl. No.: 10/733,940

(22) Filed: Dec. 11, 2003

(51) Int. Cl. G06F 17/60

(52) U.S. Cl. 705/5

(57) ABSTRACT

A fare searching program preferably implemented as a website connected to at least one source (14) of airfare information through a network (16) and one or more user computers (18). The program collects a lowest airfare currently available (LACA) for a plurality of city pairs by performing a daily search of the source (14). The program also stores the LACA for future retrieval, then referred to as lowest airfare historically available (LAHA). The LAHA may be averaged on a monthly and annual basis, thereby creating monthly averages and an annual average for a preceding twelve months. In use, the program retrieves a LACA between a selected city pair for the current day. Then, the program graphs the monthly and annual averages for the selected city pair and displays the LACA for the current day, thereby allowing a user to compare the LACA for the current day with previously stored LAHA.

### BACKGROUND OF THE INVENTION

1. Field of the Invention

The present invention relates to the travel industry. More particularly, the present invention relates to a fare searching program and method that compares a lowest airfare currently available (LACA) with lowest airfare historically available (LAHA) in order to determine when to purchase airline tickets.

2. Description of Prior Art

Many travelers purchase airline tickets and other travel-related services over the Internet. To facilitate this, there are many travel web-sites that search for airfares and report back to travelers, such as Travelocity®, Orbitz®, or CheapTickets®. Travelers may then choose an airline and/or a particular flight by comparing airfares and other information provide by the travel web-sites.

Since travelers typically plan trips in advance, they may have an opportunity to wait until airfares and/or other costs come down. However, current travel web-sites only report airfares that are currently available. Thus, travelers have no way to predict whether reported airfares are low or high, with respect to monthly or annual averages.

While some travel web-sites report airfares on a daily basis, these travel web-sites still only report airfares that are currently available on any given day. Thus, it is left to individual travelers to compare reports. Since most travelers do not decide where to travel more than a few months in advance, travelers can only collect airfare reports for one or two months before they must make a decision about purchasing tickets. This significantly limits the information from which to make their decision.

Accordingly, there is a need for an improved fare searching program and method that overcomes the limitations of the prior art.

### SUMMARY OF THE INVENTION

The present invention overcomes the above-identified problems and provides a distinct advance in the art of fare searching programs. More particularly, the present invention provides a fare searching program and method that compares a lowest airfare currently available (LACA) with lowest airfare historically available (LAHA) in order to permit a traveler to determine when to purchase airline tickets.

The program preferably controls a website hosted by one or more servers connected to at least one source of airfares through a network, such as the Internet, and one or more user computers. The server preferably includes a processor, a memory accessible to the processor for storing the program of the invention, and a data storage medium accessible to the processor for storing results produced by the program as executed by the processor. The program collects the LACA for a plurality of city pairs by performing a plurality of daily searches of the sources. The LACA are then stored in the storage medium. LACA that has been previously stored, and is later retrieved, is then referred to as the LAHA.

On any given day, the program may calculate and graph monthly averages and an annual average for a selected one of the city pairs. The program also preferably searches for, retrieves, and displays a LACA for the given day between the selected city pair. In this manner, the program allows a user to compare the LACA for the given day with the LAHA.

Importantly, the program is not concerned with actual travel days. Rather, the program is concerned with airfares that are available on the given day, and airfares that were available in the past, for the selected city pair. For example, a user may choose to view airfares from St. Louis to Orlando. In this case, suppose the monthly average for the preceding July, August, September, and October were approximately $137, $160, $190, and $195, respectively. By displaying these monthly averages, the program indicates that the best time to purchase an airline ticket from St. Louis to Orlando may be in July and the worst time to purchase an airline ticket from St. Louis to Orlando may be in October.

As discussed above, the program also displays the LACA for the given day. For instance, suppose the LACA for the given day from St. Louis to Orlando is $118. In this case, the user can see that not only is the given day's LACA well below the annual average, but that the given day's LACA is also well below the preceding July's monthly average. Thus, the current day appears to be a very good day to purchase an airline ticket from St. Louis to Orlando.

It can be seen that the user may determine which months may be better than others for planning travel and purchasing airline tickets. The user may also determine whether the LACA is below a corresponding monthly average, thereby indicating that the given day is especially advantageous for purchasing airline tickets. Once the user decides to purchase a ticket, the program may facilitate a purchase, by any method commonly used, or may redirect the user to another website which will facilitate the purchase.

### BRIEF DESCRIPTION OF THE DRAWINGS

A preferred embodiment of the present invention is described in detail below with reference to the attached drawing figures, wherein:

FIG. 1 is a schematic view of certain computer and telecommunications equipment which may be used to implement a fare searching program constructed in accordance with a preferred embodiment of the present invention;

FIG. 2 is a block diagram of selected tools of the program;

FIG. 3 is a flow chart showing a preferred daily operation of the program;

FIG. 4 is a flow chart showing a preferred on-demand operation of the program; and

FIG. 5 is a graph that may be generated by the program.

### DETAILED DESCRIPTION OF A PREFERRED EMBODIMENT

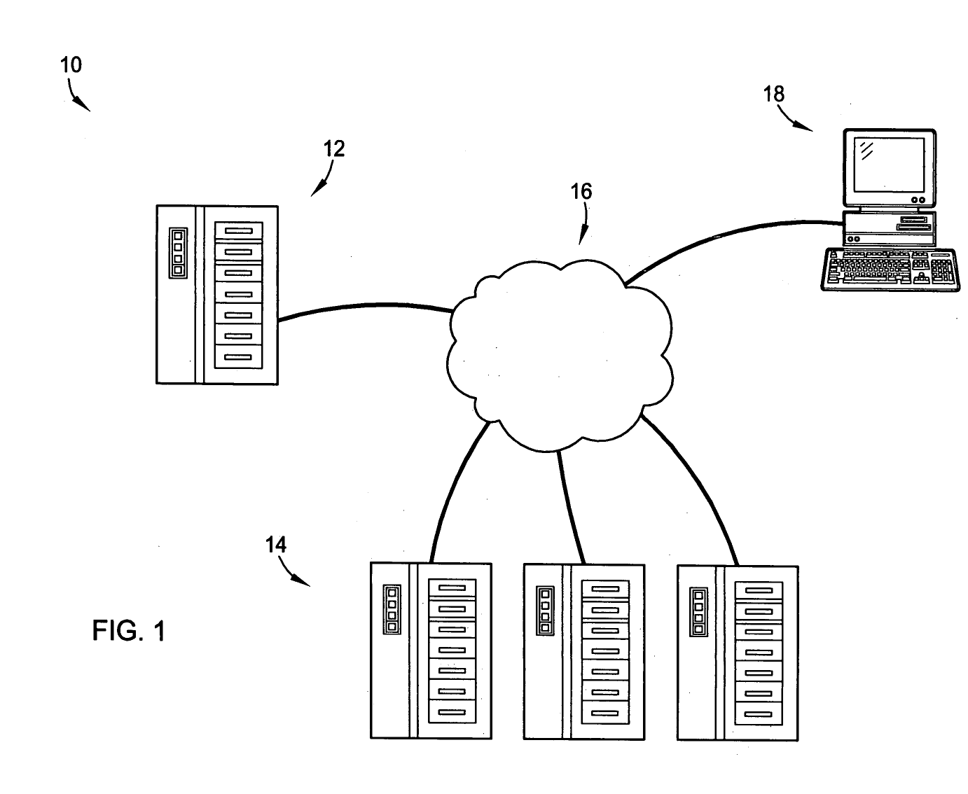

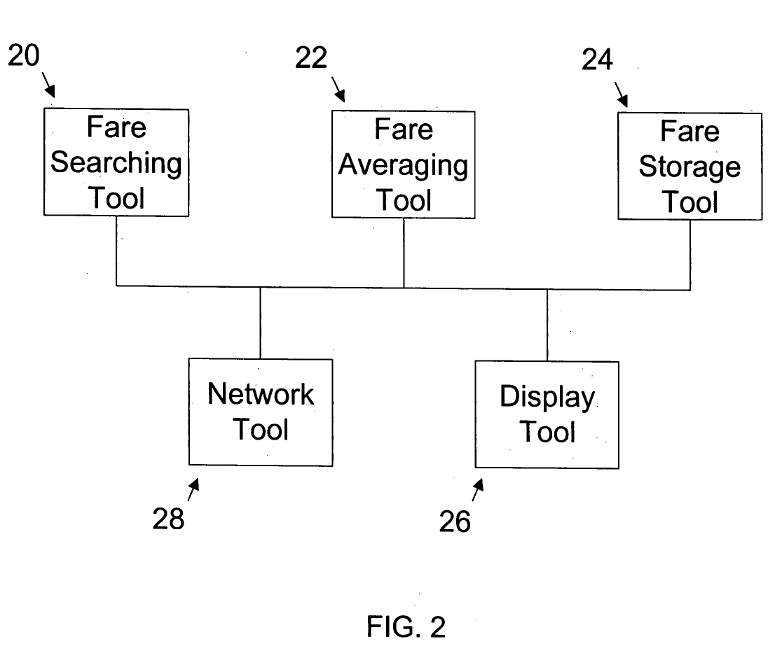

Referring to FIGS. 1 and 2, the preferred fare searching program constructed in accordance with a preferred embodiment of the present invention is preferably used in connection with certain computer and telecommunications equipment 10. Specifically, the program preferably controls a website hosted by one or more servers 12 connected to at least one source 14 of airfares through a network 16, such as the Internet, a local area network, or a wide area network, and one or more user computers 18. The servers 12, or equivalent computer systems, are preferably of the type available from Compaq®, Dell®, IBM@, or Sun Microsystems®. The server 12 preferably includes a processor, a memory accessible to the processor for storing the program, and a data storage medium accessible to the processor for storing results produced by the program as executed by the processor and described in further detail below.

The source 14 is preferably operated by Airline Tariff Publishing Company (ATPCO), or another similar service. Suppliers, such as airlines, currently publish their airfares to ATPCO. ATPCO then distributes the airfares from several suppliers to clients who subscribe to ATPCO's service. For example, the program preferably receives airfares from ATPCO eight times each day and stores those airfares for up to thirteen months in the storage medium of the server 12. The program may specifically request the airfares from ATPCO or ATPCO may independently send the airfares. In other words, either the program or the source 14 may initiate transfer of the airfares from the source 14 to the program. Thus, retrieve is synonymous with receive, as used throughout this document.

Alternatively, the source 14 may include airline servers, intermediate fare providers, or both. The airline servers are preferably operated directly by the airlines, such as United Airlines®, American Airlines®, U.S. Airways®, etc. The intermediate airfare providers are preferably travel-related websites such as Travelocity®, Orbitz®, or CheapTickets®. Where the source 14 includes the airline servers, the program is able to retrieve the airfares directly from the airlines associated with the airline servers, thereby potentially retrieving the most recent and reliable airfares. However, this configuration may not be able to retrieve discounts available to a particular user or those discounts that may be available through another source.

Where the source 14 includes the intermediate airfare providers, the program is able to retrieve several airfares for each conforming flight of each of the airlines. For example, the program may retrieve airfares for each flight between St. Louis and Orlando from Travelocity®, Orbitz®, and CheapTickets®. In this manner, the program is expected to retrieve potentially different airfares for each conforming fight. However, the intermediate airfare providers may not have the most recent and reliable airfares and may not include all possible discounts to which the user is entitled.

Furthermore, the source 14 may include any combination of the above described sources of airfare information. In this case, the program may receive or retrieve airfares for specific flights from ATPCO, United Airlines®, American Airlines®, U.S. Airways®, Travelocity®, Orbitz®, CheapTickets®, and/or any other sources of airfare information. In this manner, the program receives many potentially different airfares for each conforming flight. However, some of the airfares from some of the sources 14 may not be accurate. Thus, the program may also be configured to ignore any of the sources 14.

The program may be configured to operate for a plurality of city pairs. For example, the program may substantially simultaneously retrieve airfares between St. Louis and Orlando, Atlanta and Chicago, Birmingham and Cincinnati, Charlotte and Dallas, Houston and Austin, or any combination of these cities and/or other cites. The number of city pairs is essentially only limited by the capacity and limitations of the storage medium, which stores the airfares for use by the program.

The program performs a daily search of the sources 14 or otherwise receives the airfares for each conforming flight available through each source 14. The program analyzes each airfare and chooses a lowest airfare currently available (LACA) from the source 14. The program then stores the LACA for each day in the storage medium. The next day, the program again performs the daily search or otherwise receives the airfares and stores the LACA. In this manner, the LACA is stored for each day. Previously stored LACA are hereinafter referred to as lowest airfare historically available (LAHA). Since the program may receive the LACA from multiple sources 14, the LAHA reflects a true LACA for any given day in the past that was available from any of the sources 14.

Since the program is implemented and configured to compare LACA to LAHA, the program is preferably configured and then allowed to perform the daily searches or otherwise receive the airfares for a specified period, such as a month. Once the program has collected an adequate volume of the LAHA, the program may then be used to compare the LACA to the LAHA.

The program preferably averages the LAHA, thereby creating a monthly average for each month of a preceding year and an annual average for the preceding year, on demand. For example, when the program is asked to compare the LACA to the LAHA, the program may retrieve the LAHA from the storage medium and create the monthly and annual averages. The program may then graph or otherwise display the monthly and annual averages along with the LACA, as will be discussed in further detail below.

Specifically, in the preferred embodiment, each monthly average is preferably created by averaging the ten lowest LAHA for that month. The annual average is preferably created by averaging the LAHA that was used to create each monthly average, or the ten lowest LAHA for each month. The averages may also be created by averaging the LAHA for each day of the preceding year. The averages may also be created on a scheduled basis, such as once a month or twice a month. For example, at the end of each month, the program may average the LAHA for that month, thereby creating the monthly averages, and then recalculate the annual average once each month.

The program may be implemented as one or more routines or tools. For example, the program may comprise a fare searching tool 20 to perform the daily searches of the sources 14 for the LACA, an averaging tool 22 to create the monthly and annual averages, and a fare storage tool 24 to store the LACA and/or the averages. The program may also comprise a display tool 26 to graph or otherwise display the averages and a network connectivity tool 28 to manage access to the network 16. Any of the tools 20,22,24,26,28 may reside on the website or on one of the user computers 18 operated by each of a plurality of independent users. For example, each user may concurrently run an individual instance of the program and each instance of the program may be configured differently. For example, each instance of the program may be configured to operate with different city pairs and/or search different ones of the sources 14.

Alternatively, selected tools may be common to all users, while other tools may be specific to each user. For example, a specific instance of the display tool 26 may be unique to a specific user and reside on a specific one of the user computers 18, while the remaining tools 20,22,24,28 reside on the server 12 of the website and are common to all users. With this in mind, any of the tools 20,22,24,26,28 at the server 12 may be configured and maintained by an administrator, while any of the tools 20,22,24,26,28 on the user computers 18 may be individually maintained by each user.

While the present invention has been described above, it is understood that substitutions may be made. For example, the program may be used with other forms of travel, such as bus lines, train lines, and cruise lines. Furthermore, the program may be used for other goods and services. Additionally, the program may be configured to search the storage medium 12 and/or the sources 14 for the LACA immediately before displaying the LACA and LAHA. Any of the tools 20,22,24,26,28 may also be combined. For example, the fare searching tool 20 may be combined with the fare storage tool 24, and therefore search for and store the LACA in one step. Furthermore, rather than calculating the monthly average, the program may simply store the lowest LACA for each month. Alternatively, the program may calculate the monthly average using virtually any number of the lowest LACA for each month. For example, the monthly average may be calculated using 2, 3, 7, 10, or 30 of the lowest LACA for each month. Finally, while the program is preferably concerned only with the airfares that are available on the given day, the program may also be configured to perform the daily searches for actual travel days. These and other minor modifications are within the scope of the present invention.

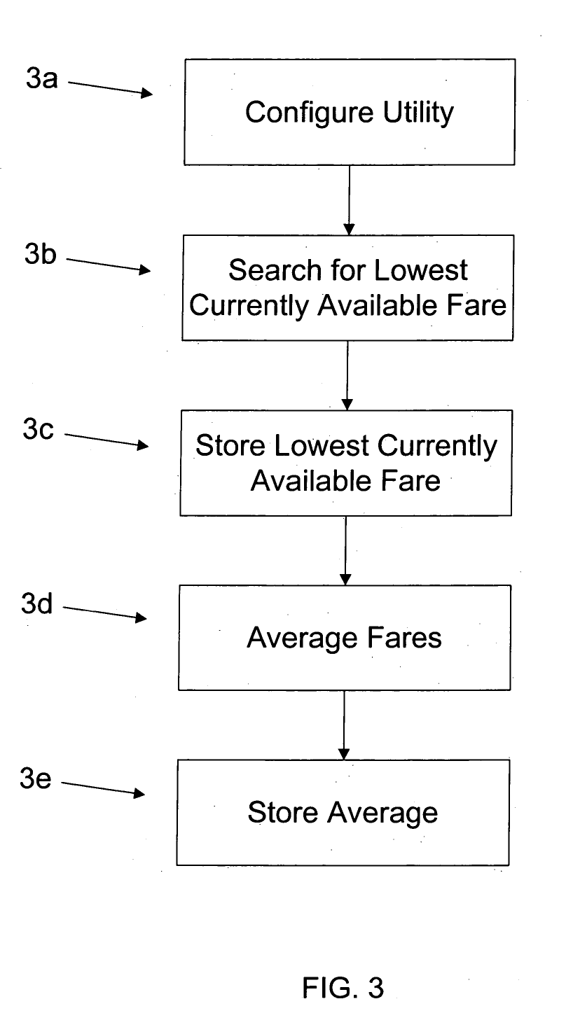

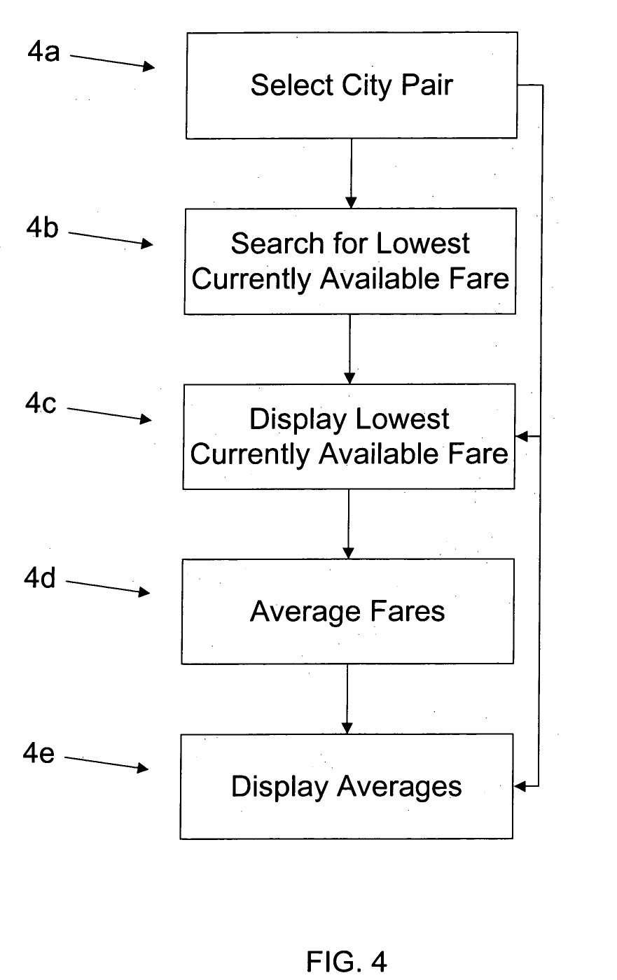

The flow charts of FIGS. 3 and 4 show the functionality and operation of a preferred implementation of the present invention in more detail. In this regard, some of the blocks of the flow charts may represent a module segment or portion of code of the program of the present invention which comprises one or more executable instructions for implementing the specified logical function or functions. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

FIG. 3 shows the program's 10 daily operation. First, the administrator or one of the users configures the program by selecting one or more city pairs for which LACAs should be retrieved and stored, as depicted in step 3a. Each day, the program performs the daily search for the LACA, as depicted in step 3b. It is important to note that the program preferably performs the daily searches without user intervention. The program may report results and/or problems, such as network outages, on a daily basis or as they occur. The program stores the LACA found during the daily search, as depicted in step 3c. The program uses the LAHA to create the monthly and annual averages, as depicted in step 3d. Finally, the program may store the averages, as depicted in step 3e.

On demand, as shown in FIG. 4, the user may access the program and to view the LACA and LAHA stored therein. First, the user selects one of the city pairs, as depicted in step 4a. The program searches for the LACA and LAHA, as depicted in step 4b. The program displays the LACA, as depicted in step 4c. While the program may be configured to calculate the averages once each month, the program may be configured to calculate the averages immediately before displaying them, as depicted in steps 4d and 4e.

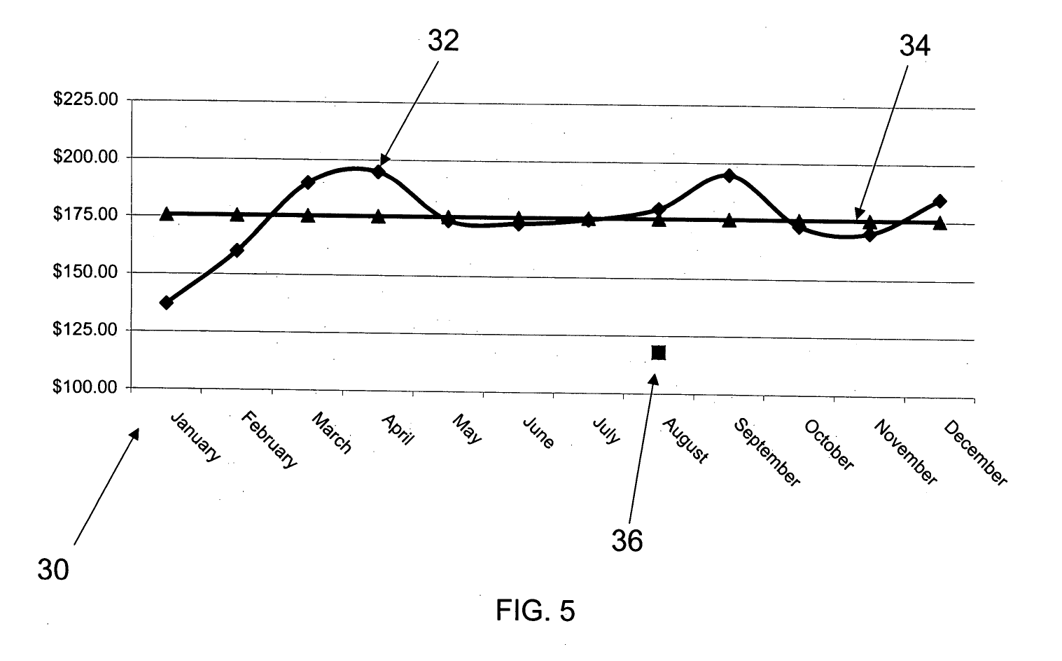

Referring also to FIG. 5, as discussed above, the program preferably displays the averages as a graph 30. The graph 30 preferably includes a monthly average trend 32 and an annual average trend 34. The graph 30 may also include a point 36 to depict the LACA for the given day. Alternatively, the LACA for the given day may simply be displayed as a number. In this manner, the user may determine when to purchase airline tickets. For example, if the LACA for the given day is lower than any of the monthly averages, then the given day may be good for purchasing the tickets. If the user so decides, the program may facilitate a purchase, by any method commonly used, or may redirect the user to another website which will facilitate the purchase.

Having thus described a preferred embodiment of the invention, what is claimed as new and desired to be protected by Letters Patent includes the following:

1. A fare searching program comprising:
a fare searching tool operable to perform a daily search for a lowest fare available on a current day for transportation between a city pair; and
a fare storage tool operable to store the lowest fare for each of a plurality of months so that the lowest fare for each month may be recalled and compared in the future.

2. The program of claim 1, further including an averaging tool operable to average each of the lowest fares corresponding to a plurality of days in each of a preceding twelve months thereby creating a monthly average of the lowest fares for each month.

3. The program of claim 2, wherein the averaging tool is further operable to average the monthly averages thereby creating an annual average of the lowest fares.

4. The program of claim 2, further including a display tool operable to display the monthly averages corresponding to each of the months.

5. The program of claim 4, wherein the display tool is further operable to display the lowest fare available on the current day.

6. The program of claim 1, further including a network connectivity tool operable to connect with a fare source so that the fare searching tool may search the fare source.

7. The program of claim 1, wherein the averaging tool is further operable to average the lowest fares corresponding to the months thereby creating an annual average of the lowest fares.

8. A fare searching program for comparing currently available fares for transportation between a selected city-pair with historically available fares for transportation between the selected city-pair, the program comprising:
a fare searching tool operable to perform a daily search for a lowest fare available on a current day for fare between one of a plurality of pre-selected city pairs;
an averaging tool operable to average each of the lowest fares corresponding to a plurality of days in each of twelve months thereby creating a monthly average of the lowest fares for each month and for each city pair;
a fare storage tool operable to store the monthly average so that the monthly average may be recalled up to one year into the future and compared to fares available in the future; and
a display tool operable to display the monthly averages for the selected city pair and the lowest fare available on the current day for the selected city pair.

9. The program of claim 8, wherein the averaging tool is further operable to create an annual average of the lowest fares.

10. The program of claim 9, wherein the display tool is further operable to display the annual average corresponding to a preceding twelve months for the selected city pair.

11. The program of claim 8, further including a network connectivity tool operable to connect with a fare source so that the fare searching tool may search the fare source.

12. An airfare searching program for comparing currently available airfares for airline transportation between a selected city-pair with historically available airfares for airline transportation between the selected city-pair, the program comprising:
an airfare searching tool operable to perform a daily search for a lowest airfare available on a current day for airfare between each of a plurality of pre-selected city pairs;
a network connectivity tool operable to connect the searching tool with an airfare source so that the searching tool may search the airfare source;
an averaging tool operable to average each of the lowest airfares corresponding to each day of each of twelve months thereby creating a monthly average of the lowest airfares for each month and for each city pair;
wherein the averaging tool is further operable to create an annual average of the lowest airfares for each city pair;
an airfare storage tool operable to store the monthly averages so that the monthly averages may be recalled up to one year into the future and compared to airfares available in the future; and
a display tool operable to display the monthly averages, the annual average corresponding to a preceding twelve months, and the lowest airfare available on the current day for the selected city pair.

13. A method of searching for a lowest available fare for transportation between a selected city pair, the method comprising the steps of:
(a) receiving in a computer system indication of a plurality of city pairs;
(b) establishing a connection between the computer system and a fare source over a network;
(c) receiving in the computer system information relating to the lowest fare currently available from the fare source for at least the selected city pair;
(d) repeating steps (b) and (c) for each day of a current month; and
(e) calculating in the computer system a monthly average of the lowest fares currently available for the month.

14. The method as set forth in claim 13, further including the step of:
(f) storing in the computer system at least two of the lowest fares currently available for the month, such that the monthly average may be calculated for up to one year.

15. The method as set forth in claim 13, repeating steps (b) thru (d) for each month of a preceding year such that the computer system may calculate at least twelve monthly averages corresponding to each month of the preceding year.

16. The method as set forth in claim 15, further including the steps of:
(g) receiving in the computer system indication of the selected city pair;
(h) displaying the lowest fare currently available for the selected city pair;
(i) calculating the monthly averages for the preceding year for the selected city pair; and
(j) displaying the monthly averages.

17. The method as set forth in claim 16, further including the steps of calculating an annual average for the preceding year for the selected city pair and displaying the annual average.

18. A method of searching for a lowest available airfare for airline transportation between a selected city pair, the method comprising the steps of:
(a) receiving in a computer system indication of a plurality of city pairs;
(b) establishing a connection between the computer system and an airfare source over a network;
(c) receiving in the computer system information relating to the lowest airfare currently available from the airfare source for each of the city pairs;
(d) repeating steps (b) and (c) for each day of a current month;
(e) calculating in the computer system a monthly average of the lowest airfares currently available for at least two days of the current month;
(f) storing in the computer system the lowest airfares currently available for at least two days of the current month, such that the monthly average may be calculated for up to one year;
(g) repeating step (f) for each month of a preceding year such that the computer system may calculate at least twelve monthly averages corresponding to each month of the preceding year; and
(h) calculating in the computer system an annual average for the preceding year.

19. The method as set forth in claim 18, further including the steps of:
(i) receiving in the computer system indication of the selected city pair;
(j) displaying the lowest airfare currently available for the selected city pair;
(k) displaying the monthly averages for the preceding year for the selected city pair; and
(l) displaying the annual average for the preceding year for the selected city pair.

20. The method as set forth in claim 18, wherein step (f) comprises storing a ten lowest ones of the lowest airfares currently available of the current month, thereby allowing the computer system to calculate the monthly averages by averaging the ten lowest airfares for each month.
